(19) United States
(12) Patent Application Publication
(10) Pub. No.: US 2016/0063930 A1
(43) Pub. Date: Mar. 3, 2016

(54) ELECTRO-OPTICAL DEVICE AND ELECTRONIC APPARATUS

(71) Applicant: Seiko Epson Corporation, Tokyo (JP)

(72) Inventors: Tetsuro Yamazaki, Shiojiri-shi (JP); Mitsutoshi Miyasaka, Suwa-shi (JP)

(21) Appl. No.: 14/819,226

(22) Filed: Aug. 5, 2015

(30) Foreign Application Priority Data
Aug. 26, 2014 (JP) 2014-171263

(51) Int. Cl. G09G 3/36

(52) U.S. Cl. CPC G09G 3/36; G09G 2330/028

(57) ABSTRACT

The electro-optical device includes a first substrate, a second substrate, and an electro-optical material that is sandwiched between the first substrate and the second substrate. Pixel electrodes on the first substrate and pixel electrodes on the second substrate are arranged to coincide. The first substrate is driven by a first power supply, the second substrate is driven by a second power supply, and a potential of the first power supply and a potential of the second power supply are different from each other.

### BACKGROUND

1. Technical Field

The present invention relates to electro-optical devices and electronic apparatuses.

2. Related Art

In an electronic apparatus with a display function, a transmissive electro-optical device or a reflective electro-optical device has been employed. An electro-optical device receives and modulates light, which is transmitted or reflected to display images or is projected onto a screen to form a projection image. As an electro-optical device in such an electronic apparatus, a liquid crystal display is known, in which images are displayed utilizing dielectric anisotropy of a liquid crystal material and optical rotation in a liquid crystal layer.

A liquid crystal display includes an element substrate and a counter substrate. In addition, on an image display region of the element substrate, scanning lines and signal lines are arranged with pixels arranged in a matrix at their intersections. Each of the pixels includes a pixel transistor, via which an image signal (a pixel potential) is supplied to a pixel electrode in the pixel. On the counter substrate, on the other hand, a common electrode is formed. Images are displayed in accordance with a potential difference between the common electrode and the pixel electrode.

To a liquid crystal display, analog signals are input as an image signal. Since digital signals are output from personal computers, televisions, and the like, a liquid crystal display needs a digital-to-analog converter (DAC) circuit for converting digital signals into analog signals. With regard to a technique for forming a DAC using thin film transistors, see for example, JP-A-11-272242.

However, there has been a problem in that when properties of thin film transistors vary, it is very difficult to form a DAC having a stable property. Unstable operation of a DAC results in display unevenness. That is, there has been a problem in that it is difficult to perform high-quality display by inputting digital signals to an electro-optical device.

### SUMMARY

An advantage of some aspects of the invention is to solve at least a part of the problems described above, and the invention can be realized as the following aspects or application examples.

### APPLICATION EXAMPLE 1

An electro-optical device according to this application example includes a first substrate on which an array of first pixel electrodes is arranged; a second substrate on which an array of second pixel electrodes is arranged and which is placed so as to face the first substrate; and an electro-optical material that is sandwiched between the first substrate and the second substrate. The first pixel electrodes and the second pixel electrode substantially coincide in plan view. One of the array of first pixel electrodes and the array of second pixel electrodes is driven by a first power supply that supplies a first high potential H1 and a first low potential L1 in a first period, the other one of the array of first pixel electrodes and the array of second pixel electrodes is driven by a second power supply that supplies a second high potential H2 and a second low potential L2 in the first period. The first high potential H1 and the second high potential H2 are different from each other, and the first low potential L1 and the second low potential L2 are different from each other.

According this application example, the first substrate and the second substrate are driven by power supply systems applying different potential values; therefore, four-gradation-level analog display can be performed using digital signals without digital-to-analog conversion using a DAC. Specifically, by combination of the potentials H1 and L1 supplied to the first substrate and H2 and L2 supplied to the second substrate, four gradation levels can be realized.

### APPLICATION EXAMPLE 2

In the electro-optical device according to the above application example, in a case where α (α>0) is defined as a voltage to be applied to the electro-optical material when the electro-optical material is at a first gradation level, β (β>0) is defined as a voltage to be applied to the electro-optical material when the electro-optical material is at a second gradation level, and γ is defined as a potential higher than 0 V; it is preferable that the first high potential H1 is α+β+γ, the first low potential L1 is β+γ, the second high potential H2 is β+γ, and the second low potential L2 is γ.

According this application example, by combination of the above-described four potentials (H1, L1, H2, and L2), four-gradation-level analog display (a dark level, a first gradation level, a second gradation level, and a bright level) can be performed without using a DAC.

### APPLICATION EXAMPLE 3

In the electro-optical device according to any of the above application examples, in a case where a transmittance at a dark level is 0% and a transmittance at a bright level is 100%, it is preferable that a transmittance at the first gradation level is approximately 33% and a transmittance at the second gradation level is approximately 67%.

According this application example, by combination of the above-described four potentials (H1, L1, H2, and L2), analog display with four gradation levels (black, dark gray, light gray, and white) with transmittances of 0%, 33%, 67%, and 100% can be performed without using a DAC.

### APPLICATION EXAMPLE 4

In the electro-optical device according to any of the above application examples, it is preferable that a first scanning line to which a first scanning signal is supplied is formed on the first substrate, and a second scanning line to which a second scanning signal is supplied is formed on the second substrate, the first scanning signal and the second scanning signal are driven by a third power supply that supplies a third high potential H3 and a third low potential L3, the third high potential H3 is equal to or higher than the first high potential H1, and the third low potential L3 is equal to or higher than 0 V and equal to or lower than the second low potential L2.

According this application example, since the third high potential H3 is higher than the first high potential H1, an image signal is supplied to a pixel electrode via a pixel transistor such as a first transistor or a second transistor. In addition, since the third low potential L3 is higher than 0 V, a minus potential does not need to be used, which simplifies circuit control. In addition, since the third low potential L3 is lower than the second low potential L2, the first transistor and the second transistor are kept off when not selected, so that an image signal can be held in the pixel.

### APPLICATION EXAMPLE 5

In the electro-optical device according to any of the above application examples, it is preferable that in a second period that follows the first period, the one of the array of first pixel electrodes and the array of second pixel electrodes is driven by the second power supply, and the other one of the array of first pixel electrodes and the array of second pixel electrodes is driven by the first power supply.

According this application example, since positive-polarity driving and negative-polarity driving using the first substrate and the second substrate alternate, damage to an electro-optical layer (an electro-optical material) in the electro-optical device can be reduced. Thus, screen burn-in can be prevented when the electro-optical material is a liquid crystal material and reduction in a contrast ratio can be prevented when the electro-optical material is an electrophoresis material, for example.

### APPLICATION EXAMPLE 6

In the electro-optical device according to any of the above application examples, it is preferable that the first period and the second period are repeated.

According this application example, since positive-polarity driving and negative-polarity driving using the first substrate and the second substrate alternate, damage to an electro-optical material in the electro-optical device can be reduced.

### APPLICATION EXAMPLE 7

In the electro-optical device according to any of the above application examples, it is preferable that the first period is one of a plurality of subfield periods included in one frame period.

According this application example, in a case where subfield driving is employed, the number of gradation levels can be increased without changing the number of subfields, or the number of subfields can be reduced without changing the number of gradation levels.

### APPLICATION EXAMPLE 8

An electronic apparatus according this application example includes the electro-optical device according to any of the above application examples.

According this application example, an electronic apparatus including any of the above-described electro-optical devices can be provided, in which analog display can be performed by digital driving with an improved display quality.

### BRIEF DESCRIPTION OF THE DRAWINGS

The invention will be described with reference to the accompanying drawings, wherein like numbers reference like elements.

FIG. 1 is a schematic diagram illustrating a projection display device which is an example of an electronic apparatus.

FIG. 2 illustrates a liquid crystal display which is an example of an electro-optical device.

FIG. 3 is a circuit block diagram of an electro-optical device.

FIG. 4 is a circuit diagram of a pixel.

FIG. 5 illustrates a schematic cross-sectional view of a liquid crystal display.

FIG. 6 illustrates an example of an electro-optical property of an electro-optical material.

### DESCRIPTION OF EXEMPLARY EMBODIMENTS

Hereinafter, exemplary embodiments of the invention will be described with reference to the accompanying drawings. In the drawings, size scales of constituent elements are appropriately changed to clearly represent the element being described.

### Embodiment

### Overview of Electronic Apparatus

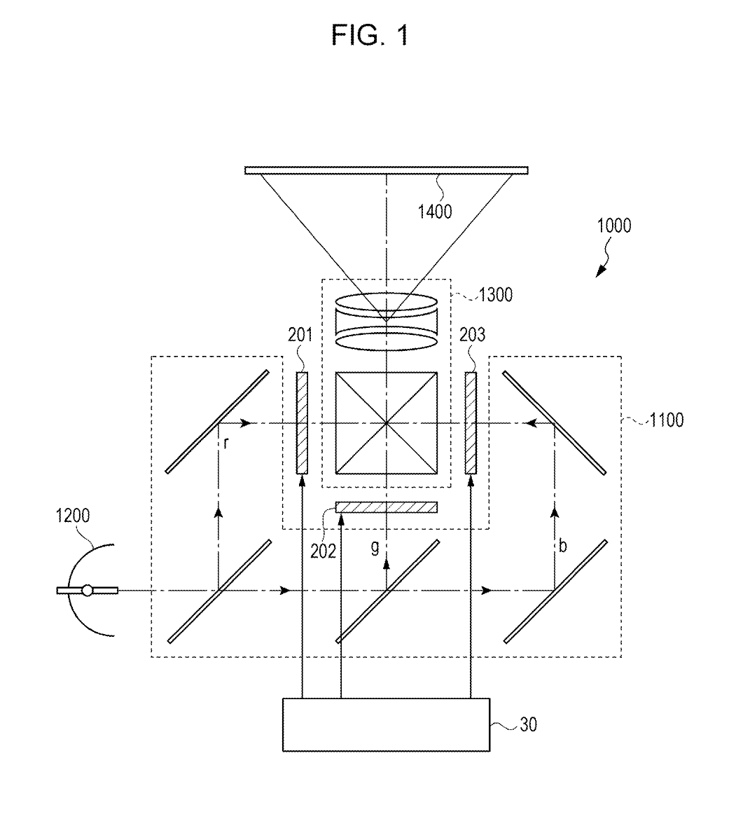

FIG. 1 is a schematic diagram illustrating a projection display device (a three-plate type projector) which is an example of an electronic apparatus. Hereinafter, a configuration of an electronic apparatus will be described with reference to FIG. 1.

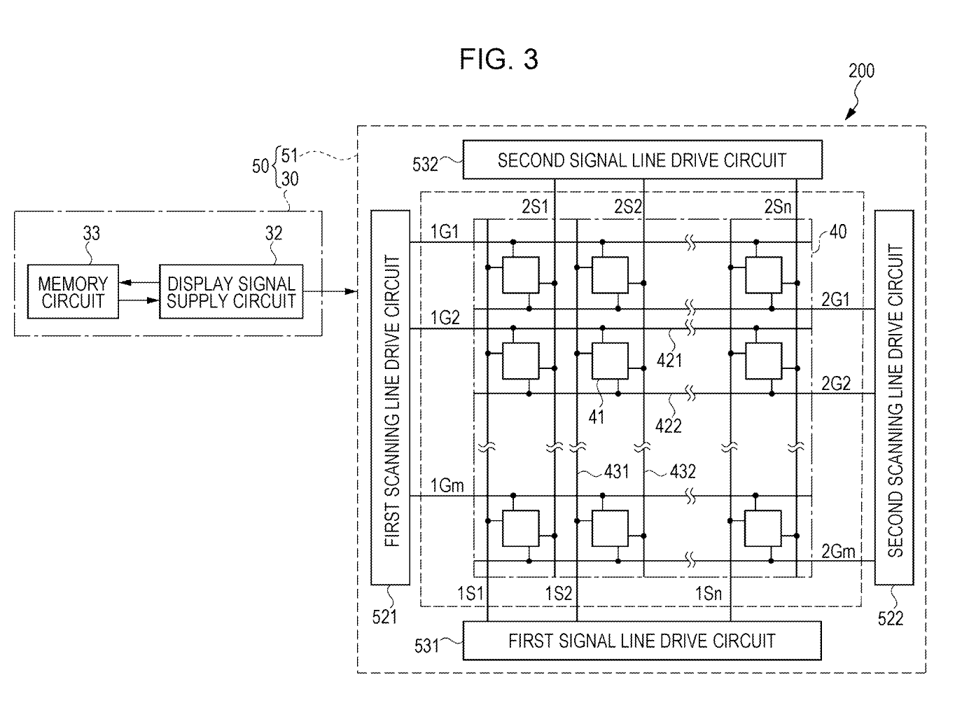

An electronic apparatus (a projection display device 1000) at least includes three electro-optical devices 200 (which is illustrated in FIG. 3 and hereinafter referred to as a first panel 201, a second panel 202, and a third panel 203) and a control device 30 which supplies a control signal to the electro-optical devices 200. The first panel 201, the second panel 202, and the third panel 203 are three electro-optical devices 200 having different display colors (e.g., red, green, and blue). Hereinafter, the first panel 201, the second panel 202, and the third panel 203 are collectively referred to as the electro-optical device 200 except for when they need to be specified individually.

An illumination optical system 1100 supplies a red component r, a green component g, and a blue component b emitted from an illumination device (a light source) 1200 to the first panel 201, the second panel 202, and the third panel 203, respectively. Each electro-optical device 200 serves as an optical modulator (a light valve) which modulates each monochromatic light supplied from the illumination optical system 1100 in accordance with a display image. A projection optical system 1300 synthesizes light emitted from the electro-optical devices 200 and projects the synthesized light onto a projection surface 1400.

### Overview of Electro-Optical Device

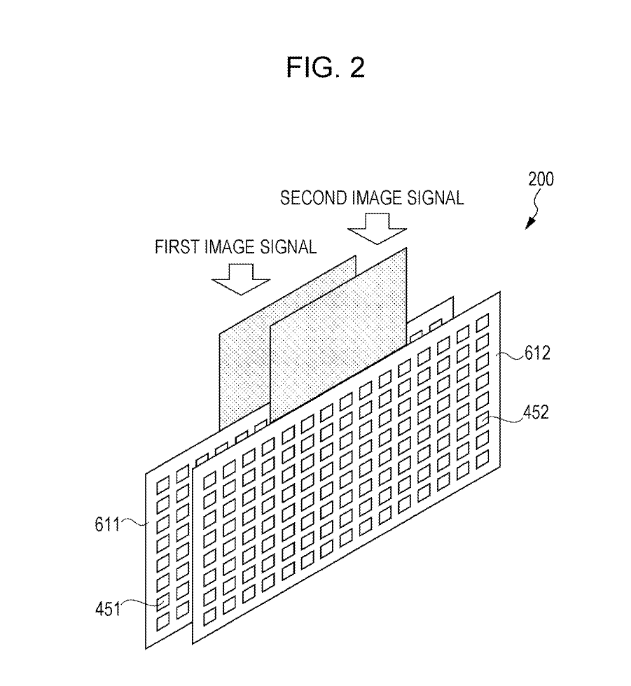

FIG. 2 illustrates a liquid crystal display which is an example of an electro-optical device. Hereinafter, the electro-optical device 200 will be outlined with reference to FIG. 2.

As illustrated in FIG. 2, the electro-optical device 200 includes a first substrate 611 and a second substrate 612 with an electro-optical material (not illustrated) therebetween. In this embodiment, a liquid crystal material 46 is used as the electro-optical material (see FIG. 5). In the electro-optical device 200, a plurality of pixels 41 (see FIG. 3) are arranged in a matrix. Each of the pixels 41 includes a first pixel electrode 451, a second pixel electrode 452, and an electro-optical material. The first pixel electrode 451 is formed on the first substrate 611 and the second pixel electrode 452 is formed on the second substrate 612; therefore, the electro-optical material is sandwiched between the first pixel electrode 451 and the second pixel electrode 452 in the pixel 41. The electro-optical device 200 further includes a drive unit 50 (see FIG. 3). The drive unit 50 supplies a first image signal and a second image signal to the first pixel electrode 451 and the second pixel electrode 452, respectively. In the pixel 41, the first pixel electrode 451 and the second pixel electrode 452 are aligned so that their sizes and positions are substantially the same when seen along a direction normal to the first substrate 611 and the second substrate 612. The electro-optical material is driven by a potential difference between the first image signal and the second image signal in each pixel 41 and an optical status is determined in each pixel 41. In other words, in the electro-optical device 200, an image is displayed in accordance with the first image signal supplied to the first pixel electrode 451 and the second image signal supplied to the second pixel electrode 452.

### Circuit Configuration of Electronic Apparatus

FIG. 3 is a circuit block diagram of an electro-optical device. Hereinafter, a circuit block configuration of the electro-optical device 200 will be described with reference to FIG. 3.

As illustrated in FIG. 3, the electro-optical device 200 at least includes a display region 40 and the drive unit 50. In the display region 40 of the electro-optical device 200, a plurality of first scanning lines 421 (to which first scanning signals are supplied) and a plurality of first signal lines 431, which intersect with each other, are formed. In the intersections of the first scanning lines 421 and the first signal lines 431, the pixels 41 are arranged in a matrix. The first scanning lines 421 extend in the row direction, whereas the first signal lines 431 extend in the column direction. In addition, in the display region 40 of the electro-optical device 200, a plurality of second scanning lines 422 (to which second scanning signals are supplied) and a plurality of second signal lines 432, which intersect with each other, are formed. In the intersections of the second scanning lines 422 and the second signal lines 432, the pixels 41 are arranged in a matrix. The second scanning lines 422 extend in the row direction, whereas the second signal lines 432 extend in the column direction. Accordingly, in each of the pixels 41 arranged in a matrix, the first scanning line 421, the first signal line 431, the second scanning line 422, and the second signal line 432 are connected. In this description, the “row direction” refers to a direction parallel to the X-axis and the “column direction” refers to a direction parallel to the Y-axis. Note that, among the first scanning lines 421, the first scanning line 421 in the i-th row is referred to as the first scanning line 1Gi, whereas among the first signal lines 431, the first signal line 431 in the j-th column is referred to as the first signal line 1Sj. Similarly, among the second scanning lines 422, the second scanning line 422 in the i-th row is referred to as the second scanning line 2Gi, whereas among the second signal lines 432, the second signal line 432 in the j-th column is referred to as the second signal line 2Sj. In the display region 40, m first scanning lines 421, m second scanning lines 422, n first signal lines 431, and n second signal lines 432 are formed (each of m and n is an integral number equal to or larger than 2). Note that in this embodiment, the electro-optical device 200 is described under the assumption that m is 2168 and n is 4112. In this case, in the display region 40 having 2168 rows and 4112 columns, images are displayed with a so-called 4K display resolution (2160 lines×4096 lines).

Various signals are supplied to the display region 40 from the drive unit 50 so that images are displayed in the display region 40. The drive unit 50 supplies drive signals to the first scanning lines 421, the first signal lines 431, the second scanning lines 422, and the second signal lines 432. Specifically, the drive unit 50 includes a drive circuit 51 which drives the pixels 41, a display signal supply circuit 32 which supplies display signals to the drive circuit 51, and a memory circuit 33. The memory circuit 33 includes a temporary memory circuit which temporarily stores frame images and a non-volatile memory circuit which stores, over a long period, a method of converting image signals into the first image signals and the second image signals. The display signal supply circuit 32 generates display signals using frame images stored in the memory circuit 33 and supplies the display signals to the drive circuit 51. The term “display signal” refers to a potential corresponding to display luminance (an image signal) of each pixel 41, a start pulse signal or a clock signal which is input to the shift register circuit, or the like.

The drive circuit 51 includes a first scanning line drive circuit 521, a first signal line drive circuit 531, a second scanning line drive circuit 522, and a second signal line drive circuit 532. The first scanning line drive circuit 521 outputs a scanning signal to each of the first scanning lines 421 so that each row of the pixels 41 is determined to be selected or not to be selected. The second scanning line drive circuit 522 outputs a scanning signal to each of the second scanning lines 422 so that each row of the pixels 41 is determined to be selected or not to be selected. The first scanning line 421 and the second scanning line 422 supply those scanning signals to the pixels 41. In other words, the first scanning lines 421 can be appropriately selected (or not selected) by the scanning signals which correspond to either selection or non-selection and are supplied from the first scanning line drive circuit 521. In addition, the second scanning lines 422 can be appropriately selected (or not selected) by the scanning signals from the second scanning line drive circuit 522. The first scanning line drive circuit 521 and the second scanning line drive circuit 522 each include a shift register circuit (not illustrated). A signal which is shifted by the shift register circuit (a start pulse signal in this embodiment) is output to each row as a shifted output signal. The shifted output signal is used to form the scanning signal. A third high potential H3 or a third low potential L3 is supplied to the first scanning line 421 and the second scanning line 422. The scanning line supplied with the third high potential H3 is selected and the scanning line supplied with the third low potential L3 is not selected.

The first scanning line drive circuit 521 and the second scanning line drive circuit 522 are synchronized and always select the same row of pixels at the same time. For example, when the first scanning line drive circuit 521 selects the first scanning line 1Gi in the i-th row, the second scanning line drive circuit 522 selects the second scanning line 2Gi in the i-th row. The first signal line drive circuit 531 supplies the first image signal to the n first signal lines 431 in synchronization with the selection of the first scanning lines 421. In addition, the second signal line drive circuit 532 supplies the second image signal to the n second signal lines 432 in synchronization with the selection of the second scanning lines 422. The first signal line drive circuit 531 and the second signal line drive circuit 532 are synchronized and supply the first image signal and the second image signal to the same row of the pixels 41. For example, when the first signal line drive circuit 531 supplies the first image signal to the first pixel electrode 451 of the pixels 41 in the i-th row pixel 41, the second signal line drive circuit 532 also supplies the second image signal to the second pixel electrode 452 of the pixels 41 in the i-th row. The first image signal is output from a first power supply which supplies a first high potential H1 and a first low potential L1 and the second image signal is output from a second power supply which supplies a second high potential H2 and a second low potential L2.

One display image is formed during one frame period. During one frame period, each of the first scanning lines 421 and each of the second scanning lines 422 are selected at least once. In general, each of the first scanning lines 421 and the second scanning lines 422 is selected once. A period during which the pixels 41 in one row are selected is referred to as a horizontal scanning period and one frame period at least includes m horizontal scanning periods. One frame period can also be referred to as a vertical scanning period since, during one period, the first scanning lines 421 and the second scanning lines 422 are sequentially selected from the first scanning line 1G1 and the second scanning line 2G1 in the first row to the first scanning line 1Gm and the second scanning line 2Gm in the m-th row (alternatively, from the first scanning line 1Gm and the second scanning line 2Gm in the m-th row to the first scanning line 1G1 and the second scanning line 2G1 in the first row).

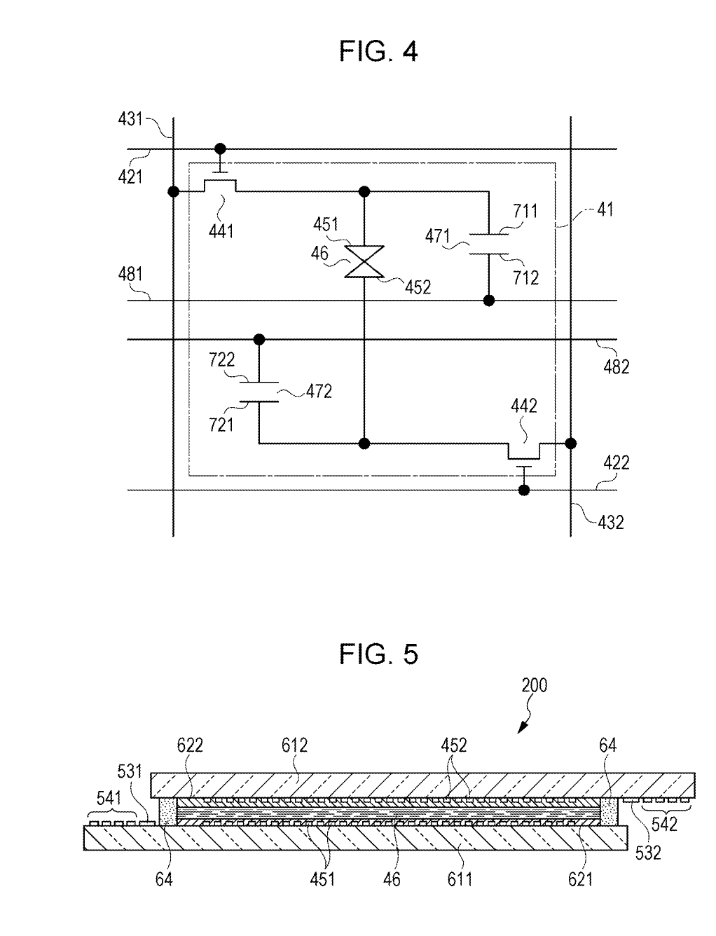

The electro-optical device 200 includes the first substrate 611 (see FIG. 5) and the second substrate 612 (see FIG. 5). On the first substrate 611, the first scanning line 421, the first signal line 431, a first transistor 441 (see FIG. 4), and the first pixel electrode 451 are formed. On the second substrate 612, the second scanning line 422, the second signal line 432, a second transistor 442 (see FIG. 4), and the second pixel electrode 452 are formed. The first scanning line drive circuit 521 and the first signal line drive circuit 531 of the drive circuit 51 are formed on the first substrate 611 using thin film elements such as thin film transistors. The second scanning line drive circuit 522 and the second signal line drive circuit 532 of the drive circuit 51 are formed on the second substrate 612 using thin film elements such as thin film transistors.

The control device 30 which includes the display signal supply circuit 32 and the memory circuit 33 is formed using a semiconductor integrated circuit on a single-crystal semiconductor substrate. The first substrate 611 includes a first mounting region 541 (see FIG. 5) in which a mounted terminal and a flexible printed circuit (FPC) are placed. A display signal is supplied from the control device 30 to the first scanning line drive circuit 521 and the first signal line drive circuit 531 of the drive circuit 51 via the mounted terminal and the FPC in the first mounting region 541. Similarly, the second substrate 612 includes a second mounting region 542 (see FIG. 5) in which a mounted terminal and an FPC are placed. A display signal is supplied from the control device 30 to the second scanning line drive circuit 522 and the second signal line drive circuit 532 of the drive circuit 51 via the mounted terminal and the FPC in the second mounting region 542. The drive circuit 51 may be formed using a semiconductor integrated circuit on a single-crystal semiconductor substrate.

### Configuration of Pixel

FIG. 4 is a circuit diagram of a pixel. Hereinafter, a configuration of the pixel 41 will be described with reference to FIG. 4.

The electro-optical device 200 in this embodiment is a liquid crystal display and an electro-optical material is the liquid crystal material 46. As illustrated in FIG. 4, the pixel 41 includes the first transistor 441, the second transistor 442, the electro-optical material (here, the liquid crystal material 46), the first pixel electrode 451, and the second pixel electrode 452. The pixel 41 includes the first pixel electrode 451 and the second pixel electrode 452, which face each other, and the liquid crystal material 46 is interposed therebetween. In accordance with an electrical field applied to the first pixel electrode 451 and the second pixel electrode 452, light transmittance of the liquid crystal material 46 changes. Note that with regard to an electro-optical material, an electrophoresis material may be used instead of the liquid crystal material 46; in such a case, the electro-optical device 200 is an electrophoresis device which can be used for an electrical book, for example.

A gate of the first transistor 441 is electrically connected to the first scanning line 421, one of a source and drain of the first transistor 441 is electrically connected to the first signal line 431, and the other of the source and drain of the first transistor 441 is electrically connected to the first pixel electrode 451. That is, the first transistor 441 controls electrical connection (electrical conduction or insulation) between the first pixel electrode 451 and the first signal line 431. In other words, when the first transistor 441 is ON, a potential being supplied to the first signal line 431 (i.e., the first image signal) is supplied to the first pixel electrode 451. In this embodiment, the first transistor 441 is an n-channel thin film transistor. The first scanning line 421 is selected when the scanning signal supplied thereto is at the third high potential H3 and not selected when the scanning signal supplied thereto is at the third low potential L3.

A gate of the second transistor 442 is electrically connected to the second scanning line 422, one of a source and drain of the second transistor 442 is electrically connected to the second signal line 432, and the other of the source and drain of the second transistor 442 is electrically connected to the second pixel electrode 452. That is, the second transistor 442 controls electrical connection (electrical conduction or insulation) between the second pixel electrode 452 and the second signal line 432. In other words, when the second transistor 442 is ON, a potential being supplied to the second signal line 432 (i.e., the second image signal) is supplied to the second pixel electrode 452. In this embodiment, the second transistor 442 is an n-channel thin film transistor. The second scanning line 422 is selected when the scanning signal supplied thereto is at the third high potential H3 and not selected when the scanning signal supplied thereto is at the third low potential L3.

A first capacitor 471 is also formed in the pixel 41 and on the first substrate 611. The first capacitor 471 holds the first image signal, which is supplied when the pixel 41 is selected, during a non-selection period of the pixel 41. The first capacitor 471 includes a first electrode 711, a second electrode 712, and a dielectric film sandwiched between these electrodes. The first electrode 711 of the first capacitor 471 is electrically connected to the first pixel electrode 451 and the second electrode 712 of the first capacitor 471 is electrically connected to a first fixed potential line 481. The first fixed potential line 481 is supplied to the first fixed potential line 481. In this embodiment, the third low potential L3 (e.g., 0 V) is supplied.

A second capacitor 472 is also formed in the pixel 41 and on the second substrate 612. The second capacitor 472 holds the second image signal, which is supplied when the pixel 41 is selected, during a non-selection period of the pixel 41. The second capacitor 472 includes a first electrode 721, a second electrode 722, and a dielectric film sandwiched between these electrodes. The first electrode 721 of the second capacitor 472 is electrically connected to the second pixel electrode 452 and the second electrode 722 of the second capacitor 472 is electrically connected to a second fixed potential line 482. A second fixed potential is supplied to the second fixed potential line 482. In this embodiment, the third low potential L3 (e.g., 0 V) is supplied. Note that the first fixed potential and the second fixed potential may be any fixed potential.

With the above-described configuration, the pixels 41 can operate in accordance with the first image signal and the second image signal. In this configuration, an optimal potential suitable for display by the electro-optical device 200 can be easily set for each pixel 41. Therefore, a high-quality image with even property can be displayed in the display region 40 and lower voltage operation and higher durability can both be realized. In addition, four-gradation-level display can be performed using digital signals, that is, analog display without using a DAC can be performed. In this embodiment, the term “analog display” of gradation levels without using a DAC means multi-gradation-level display using digital signals.

Note that in this description, the expression “a terminal 1 and a terminal 2 are electrically connected” means the terminal 1 and the terminal 2 can be in the same logic state (that is, at the same potential in a circuit design). Specifically, the terminal 1 and the terminal 2 may be directly connected via a line, or may be connected via a resistor, a switch, or the like. In other words, even when potentials of the terminal 1 and the terminal 2 are slightly different from each other, if they have the same logic state in the circuit operation, the terminal 1 and the terminal 2 can be referred to as being “electrically connected”. Therefore, as illustrated in FIG. 4 for example, in a case where the first transistor 441 is placed between the first signal line 431 and the first pixel electrode 451, when the first transistor 441 is ON, the first signal line 431 and the first pixel electrode 451 can be described as being electrically connected since the first image signal supplied to the first signal line 431 is supplied to the first pixel electrode 451.

### Configuration of Liquid Crystal Display

FIG. 5 illustrates a schematic cross-sectional view of a liquid crystal display. Hereinafter, a configuration of a liquid crystal display will be described with reference to FIG. 5. Note that in the following description, when an element is “on” another element, the following cases are included: a case where an element is placed on and in contact with another element, a case where an element is placed on another element with another element therebetween, and a case where a part of an element is placed on and in contact with another element and another part of the element is placed on the other element with yet another element therebetween.

In the electro-optical device 200 (in this example, a liquid crystal display), a pair of substrates, i.e., the first substrate 611 and the second substrate 612 are attached to each other with a sealing material 64 which has a substantially rectangular shape in plan view. The liquid crystal material 46 is sealed in a region surrounded by the sealing material 64. A liquid crystal material having a positive dielectric anisotropy is used, for example, as the liquid crystal material 46.

As illustrated in FIG. 5, a plurality of the first pixel electrodes 451 are formed on a side of the first substrate 611 which faces the liquid crystal material 46. A first alignment film 621 is formed to cover the first pixel electrodes 451. Each of the first pixel electrodes 451 is a conductive film formed of a transparent conductive material such as indium tin oxide (ITO). A plurality of the second pixel electrodes 452 are formed on a side of the second substrate 612 which faces the liquid crystal material 46. A second alignment film 622 is formed to cover the second pixel electrodes 452. The second pixel electrode 452 is a conductive film formed of a transparent conductive material such as ITO.

The liquid crystal display in this embodiment is a transmissive liquid crystal display where a polarizing plate (not illustrated) or the like is located at sides of the first substrate 611 and the second substrate 612 through which light goes in and out. Note that a configuration of the liquid crystal display is not limited thereto and a reflective or transflective electro-optical device may be used.

The electro-optical device 200 includes the first substrate 611 and the second substrate 612. On the first substrate 611, a part of the drive circuit 51 (in FIG. 5, the first signal line drive circuit 531) and the first mounting region 541 are formed. On the second substrate 612, a part of the drive circuit 51 (in FIG. 5, the second signal line drive circuit 532) and the second mounting region 542 are formed. Display signals from the control device 30 are supplied via the first mounting region 541 and the second mounting region 542 to the first scanning line drive circuit 521, the first signal line drive circuit 531, the second scanning line drive circuit 522, the second signal line drive circuit 532, and the like.

Note that the first pixel electrodes 451 and the second pixel electrodes 452 are aligned. In other words, the sizes and positions of openings of the first pixel electrode 451 are designed to be the same as those of openings of the second pixel electrode 452. The pixel 41 may optionally include a first light-blocking film around each first pixel electrode 451. In a case where the first light-blocking film is provided, an opening of the first pixel electrode 451 is a region where, seen in plan view, the first pixel electrode 451 and a region other than the first light-blocking film overlap. Similarly, the pixel 41 may optionally include a second light-blocking film around each second pixel electrode 452. In a case where the second light-blocking film is provided, an opening of the second pixel electrode 452 is a region where, seen in plan view, the second pixel electrode 452 and a region other than the second light-blocking film overlap. Note that even when the sizes and positions of openings of the first pixel electrodes 451 and those of openings of the second pixel electrodes 452 are not exactly aligned due to misalignment in a manufacturing process or the like, the first pixel electrodes 451 and the second pixel electrodes 452 can be described as being aligned.

### Driving Method

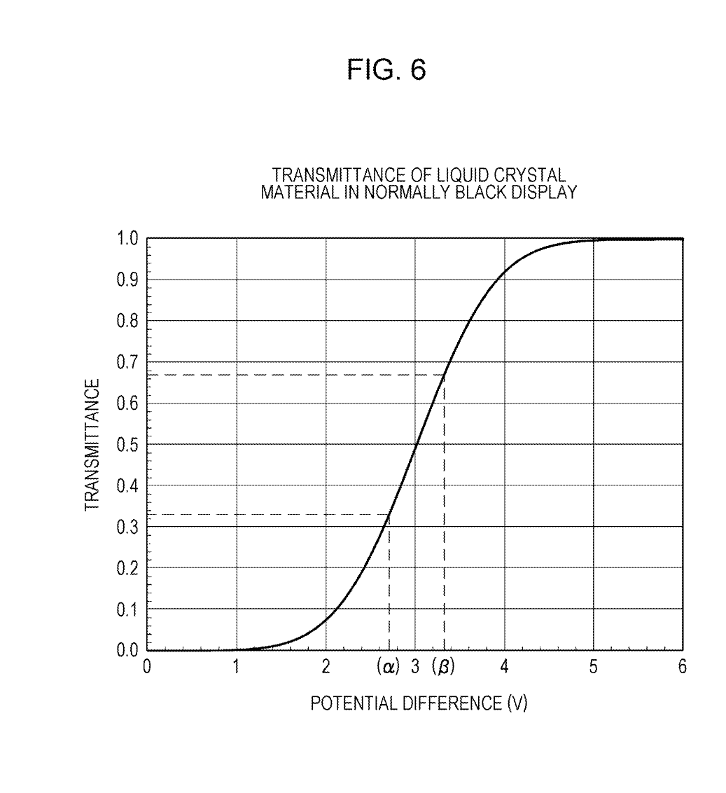

FIG. 6 illustrates an example of an electro-optical property of an electro-optical material. Hereinafter, a driving method of the electro-optical device 200 will be described with reference to FIG. 6.

The electro-optical device 200 employs a polarity inversion driving method where a first period and a second period are alternately repeated. Thus, the durability of an electro-optical material can be improved. In this embodiment, each of the first period and the second period is equal to one frame period. Therefore, the polarity is inverted every frame period. Note that the first period or the second period may be equal to a plurality of frame periods, such as two frame periods.

The drive unit 50 supplies the first image signal, specifically the first high potential H1 or the first low potential L1 to the first pixel electrodes 451 during the first period (in this embodiment, the first period is an odd-numbered frame period). The drive unit 50 supplies the second image signal, specifically the second high potential H2 and the second low potential L2 to the second pixel electrodes 452 during the first period. In this manner, four-gradation-level display can be performed.

In this example, positive-polarity driving is performed during the first period (the odd-numbered frame period). In the first period, the pixel 41 is at one of a black level (a dark level with a transmittance of 0%), a dark gray level (a first gradation level with a transmittance of 33%), a light gray level (a second gradation level with a transmittance of 67%), and a white level (a bright level with a transmittance of 100%). Example of Positive-polarity Driving in First Period

In this example, positive-polarity driving is performed in the first period. In “positive-polarity driving” in this embodiment, a first pixel potential is higher than a second pixel potential (the first pixel potential−the second pixel potential>0). In this example, positive-polarity driving is performed during the odd-numbered frame periods.

The first substrate 611 is driven by the first power supply. The first pixel potential is either the first high potential H1 or the first low potential L1. The second substrate 612 is driven by the second power supply. The second pixel potential is either the second high potential H2 or the second low potential L2. That is, the first image signal is a digital signal at the first high potential H1 or the first low potential L1 and the second image signal is a digital signal at the second high potential H2 or the second low potential L2. Note that in this example, the transmittance of the first gradation level is 33% and that of the second gradation level is 67%.

Specifically, the above-described four potentials (H1, L1, H2, and L2) are combined to realize four levels of brightness. The transmittance at the black level is 0%, the transmittance at the dark gray gradation level is 33%, the transmittance at the light gray gradation level is 67%, and the transmittance at the white level is 100%.

FIG. 6 illustrates a transmittance curve of a normally black liquid crystal display. As is illustrated by this transmittance curve, a potential difference applied to a liquid crystal material is 0 V when the transmittance is 0%, 2.7 V when the transmittance is 33%, 3.3 V when the transmittance is 67%, and 6 V when the transmittance is 100%. Note that in this embodiment, α (α>0) is defined as a potential difference to be applied to the liquid crystal material when the transmittance is 33% and β (β>0) is defined as a potential difference to be applied to the liquid crystal material when the transmittance is 67%. Note that gradation levels (or transmittance) corresponding to the potential differences α and β can be any gradation levels. For example, α may be defined as a potential difference to be applied to the liquid crystal material when the transmittance is 25% and β may be defined as a potential difference to be applied to the liquid crystal material when the transmittance is 75%.

γ may be any value larger than 0 V, for example, γ may be 1 V. In this case, the first high potential H1 is α+β+γ, the first low potential L1 is β+γ, the second high potential H2 is β+γ, and the second low potential L2 is γ.

First, a potential corresponding to the white level (with a transmittance of 100%) will be described. Here, the pixel potential of the first substrate 611 is referred to as V1 and the pixel potential of the second substrate 612 is referred to as V2. The first pixel potential V1 is equal to H1 (=α+β+γ), which is 7 V in this example as α (2.7 V)+β (3.3 V)+γ (1 V)=7 V. The second pixel potential V2 is equal to L2 (γ), which is 1 V in this example. Therefore, the pixel potential difference (V1−V2) is 6 V as H1−L2=α+β when the pixel is at the bright level.

A potential corresponding to the light gray level (with a transmittance of 67%) will be described. The first pixel potential V1 is equal to L1 (=β+γ), which is 4.3 V in this example as β (3.3 V)+γ (1 V)=4.3 V. The second pixel potential V2 is equal to L2 (γ), which is 1 V in this example. Therefore, the pixel potential difference (V1−V2) is 3.3 V as L1−L2=β when the pixel is at a gray gradation level close to the bright level.

A potential corresponding to the dark gray level (with a transmittance of 33%) will be described. The first pixel potential V1 is equal to H1 (=α+β+γ), which is 7 V in this example as α(2.7 v)+β(3.3 v)+γ(1 V)=7 V. The second pixel potential V2 is equal to H2 (β+γ), which is 4.3 V in this example as β(3.3 v)+γ(1 V)=4.3 V. Therefore, the pixel potential difference (V1−V2) is 2.7 V as H1−H2=α and the pixel is at a gray gradation level close to the dark level.

A potential corresponding to the black level (with a transmittance of 0%) will be described. The first pixel potential V1 is equal to L1 (=β+γ), which is 4.3 V in this example as β(3.3 V)+γ(1 V)=4.3 V. The second pixel potential V2 is equal to H2 (β+γ), which is 4.3 V in this example as β (3.3 v)+γ(1 V)=4.3 V. Therefore, the pixel potential difference (V1−V2) is 0 V as L1−H2=0 V and the pixel is at the dark level.

As described above, the first substrate 611 and the second substrate 612 are driven by different power supply systems supplying different potential values; therefore, digital-to-analog conversion using a DAC is not required and four-gradation-level analog display (white, light gray, dark gray, and black) can be performed using digital signals. Specifically, by combination of the potentials H1 and L1 supplied to the first substrate 611 and the potentials H2 and L2 supplied to the second substrate 612, four levels of transmittance, i.e., 0%, 33%, 67%, and 100% can be realized. Example of Negative-polarity Driving in Second Period

Then, a negative-polarity driving in the second period is described. In “negative-polarity driving” in this embodiment, the first pixel potential is lower than the second pixel potential (the first pixel potential−the second pixel potential<0). In this example, negative-polarity driving is performed during even-numbered frame periods.

In the second period, the first substrate 611 is driven by the second power supply and the first pixel potential is either the second high potential H2 or the second low potential L2. In the second period, the second substrate 612 is driven by the first power supply and the second pixel potential is either the first high potential H1 or the first low potential L1. As in the above-described example, the driving method will be described hereinafter under the assumption that the transmittance of the first gradation level is 33% and that of the second gradation level is 67%.

The above-described four potentials (H2, L2, H1, and L1) are combined to realize four levels of brightness. As in the above-described example, the transmittance at the black level is 0%, the transmittance at the dark gray gradation level is 33%, the transmittance at the light gray gradation level is 67%, and the transmittance at the white level is 100%.

As is illustrated by the transmittance curve of FIG. 6, a potential difference applied to the liquid crystal material is 0 V when the transmittance is 0%, 2.7 V when the transmittance is 33%, 3.3 V when the transmittance is 67%, and 6 V when the transmittance is 100%. Note that in this embodiment, α (α>0) is defined as a potential difference to be applied to the liquid crystal material when the transmittance is 33% and β(β>0) is defined as a potential difference to be applied to the liquid crystal material when the transmittance is 67%.

γ is any value larger than 0 V, for example, γ may be 1 V. The second high potential H2 is β+γ, the second low potential L2 is γ, the first high potential H1 is α+β+γ, and the first low potential L1 is β+γ.

First, a potential corresponding to the white level (with a transmittance of 100%) will be described. Here, the pixel potential of the first substrate 611 is referred to as V1 and the pixel potential of the second substrate 612 is referred to as V2. The first pixel potential V1 is equal to L2 (γ), which is 1 V in this example. The second pixel potential V2 is equal to H1 (=α+β+γ), which is 7 V in this example. The pixel potential difference (V1−V2) is −6 V as L2 (1 V)−H1 (7 V)=−6 V when the pixel is at the bright level.

A potential corresponding to the light gray level (with a transmittance of 67%) will be described. The first pixel potential V1 is equal to L2 (γ), which is 1 V in this example. The second pixel potential V2 is equal to L1 (β+γ), which is 4.3 V (=3.3 V+1 V) in this example. Therefore, the pixel potential difference (V1−V2) is −3.3 V as L2 (1 V)−L1 (4.3 V)=−3.3 V when the pixel is at the gray gradation level close to the bright level.

A potential corresponding to the dark gray level (with a transmittance of 33%) will be described. The first pixel potential V1 is equal to H2 (β+γ), which is 4.3 V in this example as 3.3 V+1 V=4.3 V. The second pixel potential V2 is equal to H1 (α+β+γ), which is 7 V in this example as 2.7 V+3.3 V+1 V=7 V. Therefore, the pixel potential difference (V1−V2) is −2.7 V as H2 (4.3 V)−H1 (7 V)=−2.7 V when the pixel is at the gray gradation level close to the dark level.

A potential corresponding to the black level (with a transmittance of 0%) will be described. The first pixel potential V1 is equal to H2 (=β+γ), which is 4.3 V in this example. The second pixel potential V2 is equal to L1 (β+γ), which is 4.3 V in this example. Therefore, the pixel potential difference (V1−V2) is 0 V as H2−L1=0 V when the pixel is at the dark level.

As described above, the power supplies supplying potential to the first substrate 611 and the second substrate 612 are switched between the first period and the second period, so that polarity inversion driving is performed. Since the positive-polarity driving and the negative-polarity driving alternate, damage to the electro-optical layer (the electro-optical material) in the electro-optical device can be reduced, and, as a result, the durability of the electro-optical material can be improved.

The scanning signal is a digital signal which is either at the third high potential H3 (a selection state) or the third low potential L3 (a non-selection state). The third high potential H3 is a potential higher than α+β+γ, that is, higher than 7 V (=2.7 V+3.3 V+1 V), for example 9 V. The value of H3−(α+β+γ) is preferably higher than a threshold voltage of the first transistor 441 or a threshold voltage of the second transistor 442. The third low potential L3 is lower than γ and higher than 0 V. Specifically, the third low potential L3 is within the range of 0 V to 1 V, for example 0.5 V. The scanning signal is driven by a third power supply which supplies the third high potential H3 and the third low potential L3.

Note that unlike this embodiment, the negative-polarity driving may be performed in the first period and the positive-polarity driving may be performed in the second period. In addition, the transmittance at the first gradation level may be a transmittance other than 33%, for example, may be about 20% and the transmittance at the second gradation level may be a transmittance other than 67%, for example, may be about 80%.

Note that a normally black liquid crystal display device is employed in this embodiment, but a normally white liquid crystal display device may alternatively be employed. In a case of a normally white liquid crystal display device, like in this embodiment, a potential difference applied to a liquid crystal material is 0 V when the transmittance is 0%, 2.7 V when the transmittance is 33%, 3.3 V when the transmittance is 67%, and 6 V when the transmittance is 100%.

### Application to Subfield Driving

This embodiment can be applied to a subfield driving method. A subfield driving method refers to a method where one frame period is divided into a plurality of subfield periods or an on-potential (a high potential) or an off-potential (a low potential) is supplied to a pixel electrode in each of the subfield periods, so that either white display (with a transmittance of 100%) or black display (with a transmittance of 0%) is performed in each subfield period. Thus, a desired gradation level is displayed in one or a plurality of frame periods.

When this embodiment is applied to a subfield driving method, for example, a light gray gradation level (with a transmittance of 75%) or a dark gray gradation level (with a transmittance of 25%) may be set in each subfield period in addition to the white level and the black level.

Therefore, given that the number of subfields in one frame period is maintained, the number of gradation levels can be larger than that in a case of the white and black level display. Alternatively, given that the number of gradation levels is maintained, the number of subfields can be reduced and the period of the reduced subfields can be divided and added to the periods of other subfields, so that a writing period for a pixel potential can be increased, which leads to a reduction in writing speed and power consumption. In addition, a reduction in the number of subfields also leads to a shorter frame period, which can increase frame frequency (driving frequency) and facilitate high-speed driving (e.g., at a driving frequency of 240 Hz or 480 Hz).

### Examples of Other Electronic Apparatuses

An electronic apparatus including the electro-optical device 200 with the above-described configuration can be applied to a variety of electric apparatuses in addition to the projector described with reference to FIG. 1. Examples of electronic apparatuses include a head-up display (HUD), a head-mounted display (HMD), a smartphone, an electronic view finder (EVF), a mobile mini projector, an electrical book, a mobile phone, a mobile computer, a digital camera, a digital video camera, a display, an in-vehicle apparatus, audio equipment, a lithography apparatus, a lighting apparatus, a rear-projection television, a direct-view television, a car navigation apparatus, a pager, an electronic organizer, a calculator, a video phone, a POS terminal, and the like. Such an electronic apparatus includes the electro-optical device 200 with low power consumption and high durability which displays images at high-quality with an even property, or the electro-optical device 200 capable of regional scanning with low power consumption which displays images at high quality with an even property.

As described above in detail, with the electro-optical device 200 and the electronic apparatus according to this embodiment, the following effects can be realized.

(1) In the electro-optical device 200 according to this embodiment, the first substrate 611 is driven by the first power supply and the second substrate 612 is driven by the second power supply supplying different potentials from the first power supply in the first period. Therefore, four-gradation-level analog display (white, light gray, dark gray, and black) can be performed using digital signals without digital-to-analog conversion using a DAC.

Specifically, by combination of the potentials H1 and L1 supplied to the first substrate 611 and H2 and L2 supplied to the second substrate 612, four gradation levels with transmittances of 0%, 33%, 67%, and 100% can be realized.

(2) In the electro-optical device 200 according to this embodiment, since positive-polarity driving and negative-polarity driving using the first substrate 611 and the second substrate 612 are switched between the first period and the second period, damage to the electro-optical material in the electro-optical device 200 can be reduced. Thus, screen burn-in can be prevented.

An electronic apparatus according to this embodiment includes the above-described electro-optical device 200, so that an electronic apparatus in which high-quality analog display can be performed using digital signals can be provided.

Note that it is apparent that certain changes and modifications may be made within the scope of the claims and the entire specification. Such changes and modifications are to be considered as being included in the technological scope of the invention.

The entire disclosure of Japanese Patent Application No. 2014-171263, filed Aug. 26, 2014 is expressly incorporated by reference herein.

What is claimed is:

1. An electro-optical device comprising:
a first substrate on which an array of first pixel electrodes is arranged;
a second substrate on which an array of second pixel electrodes is arranged and which is placed so as to face the first substrate; and
an electro-optical material that is sandwiched between the first substrate and the second substrate,
wherein the first pixel electrodes and the second pixel electrode substantially coincide in plan view,
wherein one of the array of first pixel electrodes and the array of second pixel electrodes is driven by a first power supply that supplies a first high potential H1 and a first low potential L1 in a first period,
wherein the other one of the array of first pixel electrodes and the array of second pixel electrodes is driven by a second power supply that supplies a second high potential H2 and a second low potential L2 in the first period,
wherein the first high potential H1 and the second high potential H2 are different from each other, and
wherein the first low potential L1 and the second low potential L2 are different from each other.

2. The electro-optical device according to claim 1,
wherein in a case where α (α>0) is defined as a voltage to be applied to the electro-optical material when the electro-optical material is at a first gradation level, β (β>0) is defined as a voltage to be applied to the electro-optical material when the electro-optical material is at a second gradation level, and γ is defined as a potential higher than 0 V; the first high potential H1 is α+β+γ, the first low potential L1 is β+γ, the second high potential H2 is β+γ, and the second low potential L2 is γ.

3. The electro-optical device according to claim 2,
wherein in a case where a transmittance at a dark level is 0% and a transmittance at a bright level is 100%, a transmittance at the first gradation level is approximately 33% and a transmittance at the second gradation level is approximately 67%.

4. The electro-optical device according to claim 1, further comprising:
a first scanning line to which a first scanning signal is supplied and which is on the first substrate; and
a second scanning line to which a second scanning signal is supplied and which is on the second substrate,
wherein the first scanning signal and the second scanning signal are driven by a third power supply that supplies a third high potential H3 and a third low potential L3,
wherein the third high potential H3 is equal to or higher than the first high potential H1, and
wherein the third low potential L3 is equal to or higher than 0 V and equal to or lower than the second low potential L2.

5. The electro-optical device according to claim 1,
wherein in a second period that follows the first period, the one of the array of first pixel electrodes and the array of second pixel electrodes is driven by the second power supply, and the other one of the array of first pixel electrodes and the array of second pixel electrodes is driven by the first power supply.

6. The electro-optical device according to claim 5,
wherein the first period and the second period are repeated.

7. The electro-optical device according to claim 1,
wherein the first period is one of a plurality of subfield periods included in one frame period.

8. An electronic apparatus comprising the electro-optical device according to claim 1.

9. An electronic apparatus comprising the electro-optical device according to claim 2.

10. An electronic apparatus comprising the electro-optical device according to claim 3.

11. An electronic apparatus comprising the electro-optical device according to claim 4.

12. An electronic apparatus comprising the electro-optical device according to claim 5.

13. An electronic apparatus comprising the electro-optical device according to claim 6.

14. An electronic apparatus comprising the electro-optical device according to claim 7.
